(19) United States
(12) Patent Application Publication
(10) Pub. No.: US 2022/0291652 A1
(43) Pub. Date: Sep. 15, 2022

(54) ASPECT-ORIENTED PROGRAMMING BASED PROGRAMMABLE LOGIC CONTROLLER (PLC) SIMULATION

(71) Applicants: Siemens Aktiengesellschaft, Munich (DE); THE REGENTS OF THE UNIVERSITY OF CALIFORNIA, Berkeley, CA (US)

(72) Inventors: Martin Sehr, Kensington, CA (US); Juan L. Aparicio Ojea, Moraga, CA (US); Mehrdad Niknami, Oakland, CA (US); Edward Lee, Oakland, CA (US); Martin Witte, Schwabach (DE); Jörg Neidig, Nürnberg (DE)

(21) Appl. No.: 17/634,294

(22) PCT Filed: Aug. 23, 2019
(86) PCT No.: PCT/US2019/047802

§ 371 Date: Feb. 10, 2022

(51) Int. Cl. G05B 19/05

(52) U.S. Cl. CPC G05B 19/056; G05B 2219/13186

(57) ABSTRACT

Examples of techniques for aspect-oriented programming based programmable logic controller (PLC) simulation are provided. An aspect including one of a hardware configuration aspect, an execution semantics aspect, and a communication architecture aspect, may be determined to be applied to a general model of an industrial system, the general model including a PLC model and a system model. The determined aspect may be applied to the general model. The industrial system may be simulated using the general model and the applied aspect.

### BACKGROUND

The present techniques relate to programmable logic controllers (PLCs). More specifically, the techniques relate to aspect-oriented programming based PLC simulation.

While Industry 4.0, digitalization, and the Internet of Things (IIoT) may promise increased use of general-purpose software and networks in industrial applications, there may be significant risks. In industrial applications, safety, reliability, security, and efficiency may be more important than in many information technology and home automation applications. Programmable logic controllers (PLCs) that are used to control industrial applications may provide relatively simple control code running on robust, ruggedized hardware, networks with controllable real-time behaviors, and extensive availability of interoperable components such as sensors and actuators. As such, PLCs are an established platform for factory and industrial system control. PLC hardware includes a wide range of largely standardized connection options for sensors and actuators of an industrial system, powered by a programming and configuration system that provides a cyclic and prioritized execution model, including cycle time monitoring, that is adapted to industrial automation. Therefore, PLCs provide a stable runtime environment for industrial control systems with basic functionalities that may not be compromised by programming errors.

The main workload of a PLC may be done in a scan cycle, processing control tasks defined in functions (FC) or function blocks (FBs) that are called during the scan cycle. FBs operate on an internal region of memory in the PLC called the process image, in which inputs and outputs may be updated manually or automatically at specified time points such as at the beginning and end of the scan cycle. The requirements for PLC programming have gradually evolved over time. In particular, the number of control tasks per PLC, and the number of applications having differing requirements, has increased, increasing the risk of undesirable interactions. PLCs may be used in diverse industrial applications, such as processing plants, production machines, assembly lines, and ships. A PLC may implement complex control schemas, such as high-frequency motion control for synchronized drives. PLCs may be part of a real-time network on a factory floor, connecting basic sensors and actuators, distributed intelligent peripheral devices, and other industrial control systems such as protection switches, motion control systems, supervisory control and data acquisition (SCADA) systems, and edge devices. Basic function and structure of a PLC are defined in International Electrotechnical Commission (IEC) 61131-1:2003.

### SUMMARY

Embodiments of the present invention are directed to aspect-oriented programming based programmable logic controller (PLC) simulation. A non-limiting example computer-implemented method includes determining an aspect comprising one of a hardware configuration aspect, an execution semantics aspect, and a communication architecture aspect to be applied to a general model of an industrial system, the general model comprising a PLC model and a system model. The method also includes applying the determined aspect to the general model. The method also includes simulating the industrial system using the general model and the applied aspect.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

FIG. 1 is a block diagram of an example computer system for use in conjunction with aspect-oriented programming based programmable logic controller (PLC) simulation;

FIG. 2 is a block diagram of an example system for aspect-oriented programming based PLC simulation;

FIG. 3 is a process flow diagram of an example method for aspect-oriented programming based PLC simulation; and

FIG. 4 is a block diagram of an example industrial system including a PLC for use in conjunction with aspect-oriented programming based PLC simulation.

### DETAILED DESCRIPTION

Embodiments of aspect-oriented programming based programmable logic controller (PLC) simulation are provided, with exemplary embodiments being discussed below in detail. While relatively simple control systems may be designed, prototyped, and tested in the field to iterate designs, prototype-and-test design iterations may be problematic in industrial systems that include PLCs (e.g., factories and production lines), as testing of low-confidence designs in the field may be disruptive to the operation of an existing industrial system. Therefore, growth of complexity and evolving designs for PLCs may be enabled using virtual prototyping, wherein virtual simulation and verification may be used instead of prototype-and-test. Simulation of industrial systems including PLCs may be used to accelerate the commissioning of a new industrial system, and/or the modification of an existing industrial system with relatively high confidence.

Simulation of PLCs may be relatively complex, due to timing behavior dependencies in hardware and code configurations, multiple classes of threads competing for computational resources, and influence of network configuration on timing and availability of signals. Many characteristics of a PLC may be independent from the specific use case and high-level functionalities of a deployed PLC. Aspect-oriented programming may be applied to a general PLC simulation model to isolate and allow modification of such characteristics as hardware configuration, execution semantics, and communication architecture in a simulation. Application of aspects to a simulation model allows separation of the high-level objectives of PLC control code from execution semantics, communication protocols and architecture, and device hardware configuration. Embodiments of aspect-oriented programming based PLC simulation may provide a modular simulation architecture using lightweight simulation software, and enable virtual commissioning of a simulated industrial system.

Embodiments of aspect-oriented programming that may be implemented in conjunction with PLC simulation may increase software modularity by adding additional behavior to existing code (e.g., a PLC model) without modifying the existing code. In some embodiments, code that is modified using aspect-oriented programming may be specified via a pointcut specification, for example, “perform X when function Y is called”, where function Y is part of the existing code, and any instructions included in X are located outside of the existing code. This allows behaviors that are not central to the specific use case and high-level functionalities of a deployed PLC to be simulated using the PLC model without cluttering the computer code of the PLC model.

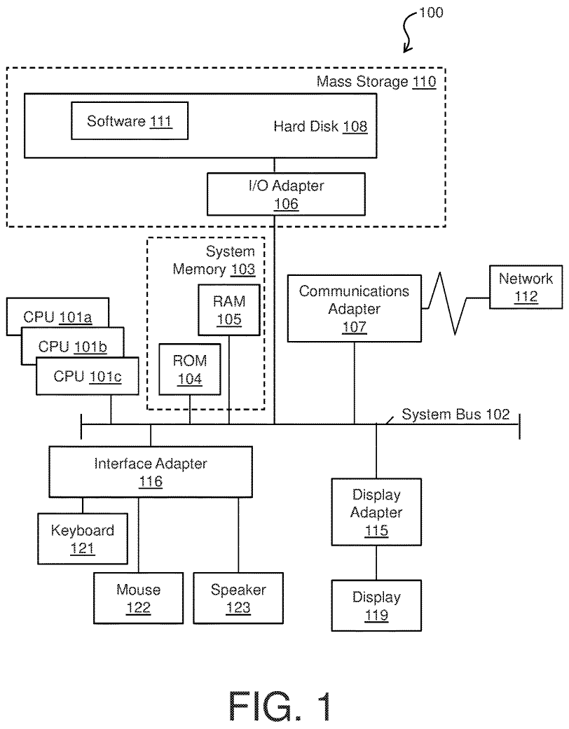

Turning now to FIG. 1, a computer system 100 is generally shown in accordance with an embodiment. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc. (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system, to coordinate the functions of the various components shown in FIG. 1.

Additional input/output devices are shown as connected to the system bus 102 via a display adapter 115 and an interface adapter 116 and. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by a display adapter 115, which may include a graphics controller to improve the performance of graphics intensive applications and a video controller. A keyboard 121, a mouse 122, a speaker 123, etc. can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 1, the computer system 100 includes processing capability in the form of the processors 101, and, storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

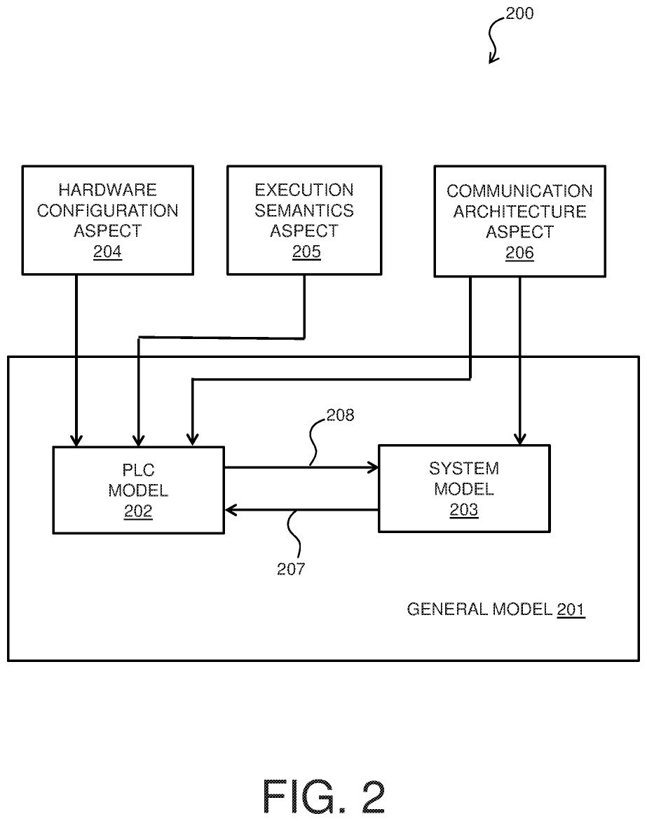

FIG. 2 is a block diagram of an example system 200 for aspect-oriented programming based PLC simulation. System 200 may be implemented in conjunction with any appropriate computer system, such as computer system 100 of FIG. 1. Embodiments of system 200 may include software 111 of FIG. 1, and may operate on data stored in hard disk 108, mass storage 110, and/or system memory 103. System 200 includes a general model 201 of an industrial system, including a PLC model 202 and a system model 203. The PLC model 202 contains a high-level model of PLC control code that is to be run in a PLC that is being simulated, and system model 203 contains a description of a system (e.g., a production line) to be controlled by the PLC model 202, that may include any appropriate elements, such as sensors, motors, and actuators. The PLC model 202 regulates system model 203 during a simulation, and may receive sensor data 207, including a plurality of sensor signals, from virtual sensors of the system model 203, and issue command data 208, including a plurality of command signals, to virtual elements (e.g., motors or actuators) of the system model 203 based on the sensor data 207. The general model 201 may be applicable to many different configurations of industrial systems. In some embodiments, a simulation that is performed using general model 201 may determine whether a new version of PLC control code that is being run in PLC model 202 is suitable for deployment to a specific instance of an industrial system in the field. In order to use the general model 201 to simulate a specific instance of an industrial system, hardware configuration aspect 204, execution semantics aspect 205, and communication architecture aspect 206 may be determined based on the characteristics of the specific instance of the industrial system, and applied to the general model 201 using aspect-oriented programming techniques. Further, hardware configuration aspect 204, execution semantics aspect 205, and/or communication architecture aspect 206 may be modified to simulate the effect of a change to the configuration of a specific instance of an industrial system using general model 201. The aspects 204, 205, and 206 enable modification of the properties of the general model 201 without alteration of the high-level logic coded in the PLC model 202 or the configuration of the system model 203.

Hardware configuration aspect 204 may specify the characteristics of the physical hardware of a PLC that is being simulated, and apply these characteristics to the PLC model 202 to simulate the execution of PLC control code in a particular industrial system using general model 201. For example, a PLC that is being simulated may include a particular memory or processor configuration that may be applied to PLC model 202 using hardware configuration aspect 204. A program component of the PLC control code may have a particular execution time when the program component is executed using the particular memory and/or processor configuration. Execution times of program components may be applied to the PLC model 202 via hardware configuration aspect 204. An execution time of a program component may also be modified using hardware configuration aspect 204. Further, hardware configuration aspect 204 may specify a new hardware configuration to be simulated before deployment into a physical PLC in a specific industrial system, such that the general model 201 may be used to virtually determine the performance of the industrial system including the new hardware configuration.

Execution semantics aspect 205 may specify a type of real-time execution that may be implemented in a PLC that is modeled by PLC model 202. For example, a PLC may implement different real-time execution principles such as time-driven execution or event-driven execution. Separating the execution semantics from the PLC model 202 using the execution semantics aspect 205 allows examination of the effect of different execution semantics on a particular control problem that is being simulated by general model 201.

In the specific instance of an industrial system that is being modeled by system 200, the sensor data and command data may be received and sent through specified ports on the PLC (e.g., each sensor, motor, and/or actuator in the industrial system may correspond to a respective port in the PLC). In some embodiments, communication architecture aspect 206 may specify specific PLC ports in PLC model 202 through which virtual sensor signals of sensor data 207 are received, and through which virtual commands of command data 208 are transmitted. In some embodiments, each virtual sensor signal of sensor data 207 may be received through a respective PLC port in PLC model 202, and each virtual command signal of command data 208 may be issued via a respective port in the PLC model 202, based on application of communication architecture aspect 206 to PLC model 202 and system model 203.

Communication architecture aspect 206 may also specify communication protocols to be used in the simulation of the specific instance of the industrial system that is performed using general model 201. The communication system of a PLC may be separated from the control code, and may support multiple types of communication between the PLC and the various elements of the industrial system, including but not limited to industrial Ethernet, process field net (PROFINET), process field bus (Profibus), Ethernet for control automation technology (Ethercat), backpanel bus, time-sensitive networking (TSN), and/or input output (10)-Link. The communication types may differ not only on a protocol level but may have different timing and encoding properties, e.g., down to level 2 in the International Organization for Standardization (ISO)/open system interconnection (OSI) stack. Separation of the communication architecture aspect 206 from the general model 201 in a simulation allows the simulation to test the effect of usage of different communication setups and types on the overall functioning of the general model 201 without having to change the general model 201.

It is to be understood that the block diagram of FIG. 2 is not intended to indicate that the system 200 is to include all of the components shown in FIG. 2. Rather, the system 200 can include any appropriate fewer or additional components not illustrated in FIG. 2 (e.g., additional PLC models, system models, aspects, computer systems, processors, memory components, embedded controllers, modules, computer networks, network interfaces, data inputs, etc.). Further, the embodiments described herein with respect to system 200 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

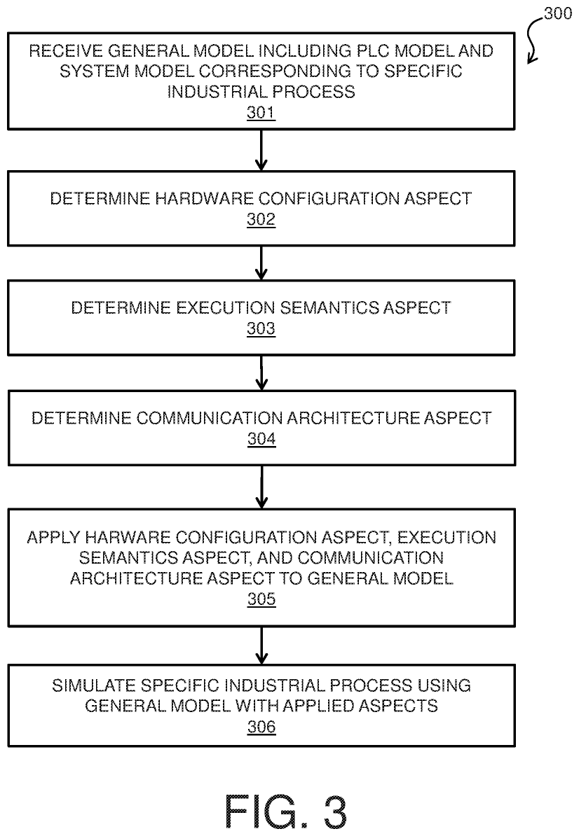

FIG. 3 is a process flow diagram of an example method 300 for aspect-oriented programming based PLC simulation. Method 300 of FIG. 3 may be implemented in conjunction with any appropriate computer device, such as computer system 100 of FIG. 1, and is discussed with reference to system 200 of FIG. 2. In block 301, a general model 201 corresponding to a specific instance of an industrial system (including but not limited to a factory, a processing plant, a production line, an assembly line, and a ship), including a PLC model 202 and a system model 203, is received. The general model 201 may be applicable to a plurality of possible industrial system configurations, including the specific industrial system that is being simulated by an instance of method 300 of FIG. 3.

The system model 203 may include virtual elements, including but not limited to sensors, motors, and actuators, corresponding to the specific industrial system. The PLC model 202 may include PLC control code that is being simulated. In various embodiments, the PLC control code may include deployed control code that is being used in the specific industrial system in the field, or control code that is being tested before deployment into the field.

In block 302, a hardware configuration aspect 204 to be applied to the PLC model 202 is determined. In various embodiments, the hardware configuration aspect 204 may specify a hardware configuration (e.g., processor and/or memory configuration) of a deployed PLC in the specific instance of the industrial system that is being simulated, or a new hardware configuration that is being tested before being deployed into the field. In some embodiments, the hardware configuration aspect 204 may specify respective execution times for various program components of the control code in the PLC model 202 based on the hardware configuration of the PLC that is being simulated.

In block 303, an execution semantics aspect 205 to be applied to the PLC model 202 is determined. The execution semantics aspect 205 may specify a type of real-time execution that may be implemented in a PLC that is modeled by PLC model 202. For example, a PLC may implement different real-time execution principles such as time-driven execution or event-driven execution. Separating the execution semantics from the PLC model 202 using the execution semantics aspect 205 allows examination of the effect of different execution semantics on a particular control problem that is being simulated by general model 201.

In block 304, a communication architecture aspect 206 to be applied to the PLC model 202 is determined. In some embodiments, communication architecture aspect 206 may specify respective ports in PLC model 202 through which virtual sensor signals of sensor data 207 are received, and through which virtual commands of command data 208 are transmitted, based on the configuration of the specific instance of the industrial system that is being simulated. Communication architecture aspect 206 may also specify communication protocols to be used in the specific instance of the industrial system that is being simulated by general model 201. The communication system of a PLC may be separated from the control code, and may support multiple types of communication between the PLC and the various elements of the industrial system, including but not limited to industrial Ethernet, PROFINET, Profibus, Ethercat, backpanel bus, TSN, and/or IO-Link. The communication types may differ not only on a protocol level but may have different timing and encoding properties, e.g., down to level 2 in the ISO/OSI stack. Separation of the communication architecture aspect 206 from the general model 201 in a simulation allows the simulation to investigate the effect of usage of different communication setups and types on the overall functioning of the general model 201 without having to change the general model 201.

In block 305, the hardware configuration aspect 204, execution semantics aspect 205, and communication architecture aspect 206 that were determined in blocks 302, 303, and 304 are applied to the general model 201. The hardware configuration aspect 204, execution semantics aspect 205, and communication architecture aspect 206 are applied to the PLC model 202. The communication architecture aspect 206 may also be applied to the system model 203. In block 306, a specific configuration of an industrial system is simulated using the general model 201 with the applied aspects, e.g., hardware configuration aspect 204, execution semantics aspect 205, and communication architecture aspect 206. The simulation of block 306 may be used for any appropriate purpose, including but not limited to testing new PLC control code or system configuration changes before deployment into a specific instance of an industrial system in the field. Based on the success of a simulation in block 306, in various embodiments, new control code may be deployed on a PLC in the specific industrial process in the field, or new hardware configuration, execution semantics, and/or communication architecture characteristics may be applied to the industrial system in the field.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

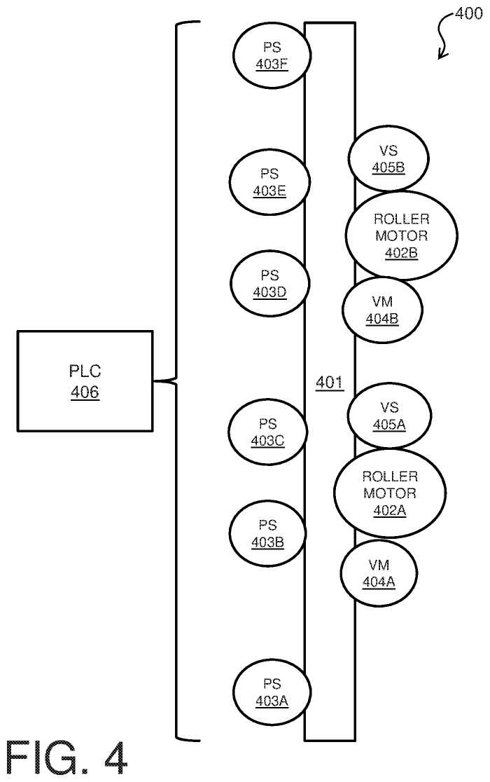

FIG. 4 is a block diagram of an example industrial system 400 including a PLC 406 for use in conjunction with aspect-oriented programming based PLC simulation. System 400 may be a specific physical instance of an industrial system that may be modeled using general model 201 of FIG. 2 according to method 300 of FIG. 3. System 400 includes a production line 401 that includes roller motors 402A-B, proximity sensors 403A-F, vibration motors 404A-B, and vibration sensors 405A-B. The proximity sensors 403A-F and vibration sensors 405A-B may each provide respective sensor signals to a PLC 406, and the PLC 406 may generate respective command signals for the roller motors 402A-B and vibration motors 404A-B based on control code in the PLC 406 and the sensor data from proximity sensors 403A-F and vibration sensors 405A-B. PLC 406 may be simulated using PLC model 202 of FIG. 2, and production line 401 may be simulated using system model 203 of FIG. 2. Characteristics of industrial system 400 may be captured in hardware configuration aspect 204, execution semantics aspect 205, and/or communication architecture aspect 206, and applied to PLC model 202 of FIG. 2, as described above with respect to method 300 of FIG. 3. Communication architecture aspect 206 may also be applied to system model 203, as described above with respect to method 300 of FIG. 3.

It is to be understood that the block diagram of FIG. 4 is not intended to indicate that the system 400 is to include all of the components shown in FIG. 4. Rather, the system 400 can include any appropriate fewer or additional components not illustrated in FIG. 4 (e.g., sensors, motors, actuators, PLCs, production lines, connections between components, etc.). Further, the embodiments described herein with respect to system 400 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
determining, by a processor, an aspect comprising one of a hardware configuration aspect, an execution semantics aspect, and a communication architecture aspect to be applied to a general model of an industrial system, the general model comprising a programmable logic controller (PLC) model and a system model;
applying the determined aspect to the general model; and
simulating the industrial system using the general model and the applied aspect.

2. The method of claim 1, wherein the aspect comprises the hardware configuration aspect, and wherein determining the aspect comprising the hardware configuration aspect comprises determining a hardware configuration of a PLC to be applied to the PLC model.

3. The method of claim 2, wherein the hardware configuration aspect comprises an execution time of a program component of control code that is executed on the PLC based on the hardware configuration of the PLC.

4. The method of claim 1, wherein the aspect comprises the execution semantics aspect, and wherein determining the aspect comprising the execution semantics aspect comprises determining a real-time execution principle to be applied to the PLC model, wherein the real time execution principle comprises one of time-driven execution and event-driven execution.

5. The method of claim 1, wherein the aspect comprises the communication architecture aspect, and wherein determining the aspect comprising the communication architecture aspect comprises determining a respective port of a PLC associated with one of a sensor signal and a command signal of the industrial system.

6. The method of claim 1, wherein the aspect comprises the communication architecture aspect, and wherein determining the aspect comprising the communication architecture aspect comprises determining one or more communication types used between a PLC and a system element of the industrial system, wherein the one or more communication types comprise one or more of industrial Ethernet, process field net (PROFINET), process field bus (Profibus), Ethernet for control automation technology (Ethercat), backpanel bus, time-sensitive networking (TSN), and input output (IO)-Link.

7. The method of claim 1, further comprising one of:
deploying control code to a PLC of the industrial system based on the simulation; and
modifying a configuration of the industrial system based on the simulation.

8. A system comprising:
a memory having computer readable instructions; and
one or more processors for executing the computer readable instructions, the computer readable instructions controlling the one or more processors to perform operations comprising:
determining an aspect comprising one of a hardware configuration aspect, an execution semantics aspect, and a communication architecture aspect to be applied to a general model of an industrial system, the general model comprising a programmable logic controller (PLC) model and a system model;
applying the determined aspect to the general model; and
simulating the industrial system using the general model and the applied aspect.

9. The system of claim 8, wherein the aspect comprises the hardware configuration aspect, and wherein determining the aspect comprising the hardware configuration aspect comprises determining a hardware configuration of a PLC to be applied to the PLC model.

10. The system of claim 9, wherein the hardware configuration aspect comprises an execution time of a program component of control code that is executed on the PLC based on the hardware configuration of the PLC.

11. The system of claim 8, wherein the aspect comprises the execution semantics aspect, and wherein determining the aspect comprising the execution semantics aspect comprises determining a real-time execution principle to be applied to the PLC model, wherein the real time execution principle comprises one of time-driven execution and event-driven execution.

12. The system of claim 8, wherein the aspect comprises the communication architecture aspect, and wherein determining the aspect comprising the communication architecture aspect comprises determining a respective port of a PLC associated with one of a sensor signal and a command signal of the industrial system.

13. The system of claim 8, wherein the aspect comprises the communication architecture aspect, and wherein determining the aspect comprising the communication architecture aspect comprises determining one or more communication types used between a PLC and a system element of the industrial system, wherein the one or more communication types comprise one or more of industrial Ethernet, process field net (PROFINET), process field bus (Profibus), Ethernet for control automation technology (Ethercat), backpanel bus, time-sensitive networking (TSN), and input output (IO)-Link.

14. The system of claim 8, further comprising one of:
deploying control code to a PLC of the industrial system based on the simulation; and
modifying a configuration of the industrial system based on the simulation.

15. A computer program product comprising a computer readable storage medium having program instructions embodied therewith, the program instructions executable by a processor to cause the processor to perform operations comprising:
determining an aspect comprising one of a hardware configuration aspect, an execution semantics aspect, and a communication architecture aspect to be applied to a general model of an industrial system, the general model comprising a programmable logic controller (PLC) model and a system model;
applying the determined aspect to the general model; and
simulating the industrial system using the general model and the applied aspect.

16. The computer program product of claim 15, wherein the aspect comprises the hardware configuration aspect, and wherein determining the aspect comprising the hardware configuration aspect comprises determining a hardware configuration of a PLC to be applied to the PLC model.

17. The computer program product of claim 16, wherein the hardware configuration aspect comprises an execution time of a program component of control code that is executed on the PLC based on the hardware configuration of the PLC.

18. The computer program product of claim 15, wherein the aspect comprises the execution semantics aspect, and wherein determining the aspect comprising the execution semantics aspect comprises determining a real-time execution principle to be applied to the PLC model, wherein the real time execution principle comprises one of time-driven execution and event-driven execution.

19. The computer program product of claim 15, wherein the aspect comprises the communication architecture aspect, and wherein determining the aspect comprising the communication architecture aspect comprises determining a respective port of a PLC associated with one of a sensor signal and a command signal of the industrial system.

20. The computer program product of claim 15, wherein the aspect comprises the communication architecture aspect, and wherein determining the aspect comprising the communication architecture aspect comprises determining one or more communication types used between a PLC and a system element of the industrial system, wherein the one or more communication types comprise one or more of industrial Ethernet, process field net (PROFINET), process field bus (Profibus), Ethernet for control automation technology (Ethercat), backpanel bus, time-sensitive networking (TSN), and input output (IO)-Link.
